(19) United States
(12) Patent Application Publication
(10) Pub. No.: US 2007/0127932 A1
(43) Pub. Date: Jun. 7, 2007

(54) METHOD, SYSTEM AND APPARATUS FOR OPTICAL PHASE MODULATION BASED ON FREQUENCY SHIFT

(76) Inventors: Bing Qi, Toronto (CA); Li Qian, Toronto (CA); Hoi-Kwong Lo, Toronto (CA); Yi Zhao, Toronto (CA)

Correspondence Address: MILLER THOMPSON, LLP, Scotia Plaza, 40 King Street West, Suite 5800, TORONTO, ON, M5H 3S1, CA

(21) Appl. No.: 11/565,684

(22) Filed: Dec. 1, 2006

Related U.S. Application Data
(60) Provisional application No. 60/741,060, filed on Dec. 1, 2005.

(51) Int. Cl. H04B 10/04; H04B 10/12

(52) U.S. Cl. 398/188

(57) ABSTRACT

The present invention provides an optical phase modulation method using optical frequency shift devices. By accurately controlling the frequency shift, the phase delay experienced by the light signal through an optical medium (fibre, free space, vacuum, or other) can be controlled with high resolution. Hence, phase change can be achieved through frequency change. This technique can be applied to a wide range of applications whenever phase modulation is needed, such as in various phase-shifted keying techniques in optical communications, and in optical metrology. The disclosed phase modulation method can also be used as a phase encoding technique in quantum key distribution.

### FIELD OF INVENTION

This invention relates generally to phase modulation methods and systems. This invention relates more particularly to a method and system for implementing optical phase modulation. The invention also relates to methods and system for measuring optical path length, which can be used to determine fibre length and dispersion. The invention also relates to methods and system for locating optical reflection sites along a light path, such as in fibre sensor array multiplexing.

### BACKGROUND OF INVENTION

Optical phase modulation is commonly employed in optical communications and quantum communications, where information can be encoded into the phase of the lightwave carrier. Conventional phase modulation methods employ a change either in the refractive index (such as an electro-optic modulator), or in the distance (such as a piezo-electric transducer-based phase modulator).

Precise fibre length measurement is important in both optical communication and optical sensing. Examples include in-service fibre line identification in a complex fibre network (see: Y. Katsuyama, J. Lightwave Technol. 13, 6 (1995)), and fibre chromatic dispersion measurement (see: K. S. Jeon, H. J. Kim, D. S. Kang, and J. K. Pan, IEEE Photonics Technol. Lett. 14, 1145 (2002)). To date, numerous length measurement techniques have been developed for various applications. The most common ones are the optical time domain reflectometer (OTDR) (see: M. K. Barnoski, M. D. Rourke, S. M. Jensen, and R. T. Melville, Appl. Opt. 16, 2375 (1977)), optical coherent domain reflectometer (OCDR) (see: R. C. Youngquist, S. Carr, and D. E. N. Davies, Opt. Lett. 12, 158 (1987); R. Hui, J. Thomas, C. Allen, B. Fu, S. Gao, IEEE Photonics Technol. Lett. 15, 96 (2003)), and the optical frequency domain reflectometer (OFDR) (see: Y. Katsuyama, J. Lightwave Technol. 13, 6 (1995); R. Passy, N. Gisin, J. P. von der Weid, and H. H. Gilgen, J. Lightwave Technol. 12, 1622 (1994)).

The OTDR determines the fibre length from the round traveling time of a short laser pulse; most commercial OTDRs have resolutions from tens of centimeters to meters. OCDRs, on the other hand, can offer much higher resolution (tens of micro-meters) based on low-coherence interference, but have very limited dynamic range (tens of centimeters) due to the limited scanning range of the reference arm. In OFDRs, either the frequency of the amplitude modulation signal or the optical frequency of the source itself is swept. The fibre length is determined by the optical frequency difference between the signal reflected by the end of testing fibre and that from a fixed reference reflector.

All these techniques are quite complicated to implement, and they either suffer from a small dynamic range or a low resolution.

In terms of interrogation of discrete optical sensors, traditional grating interrogation techniques include wavelength- and time-division multiplexing (WDM and TDM), or a combination of both (see: L. C. G. Valente, A. M. B. Braga, A. S. Ribeiro, R. D. Regazzi, W. Ecke, C. Chojetzki, R. Willsch, IEEE Sensors Journal, 3, 31, (2003)). Though these are well-established techniques, their limitations are also well recognized: the WDM technique limits the number of sensors in an array, as each sensor is allocated a distinct wavelength range; the TDM technique requires narrow pulses and high-speed time measurements. The maximum number of sensors is limited by SNR due to the large bandwidth of the narrow pulse, resulting in weak reflection from narrow-band gratings.

Recently, many new grating interrogation techniques have been proposed (see: Y. Sano, T. Yoshino, Journal of Lightwave Technology, 21, 132 (2003); S. Yamashita, T. Baba, K. Kashiwagi, Japanese Journal of Applied Physics, Part 1, 43, 8322 (2004); A. A. Chtcherbakov, P. L. Swart, Journal of Lightwave Technology, 22, 1543 (2004); P. K. C. Chan, J. Wei, M. Suleyman Demokan, IEEE Journal of Selected Topics in Quantum Electronics, 6, 756 (2000); K. Hotate, M. Enyama, S. Yamashita, Y. Nasu, Proceedings of the SPIE, 4920, 285 (2002)). Among these, the frequency-modulated continuous wave (FMCW) method and the synthesis of optical coherence function (SOCF) method use cw sources and allow grating spectrum overlap. Both involve an RF modulation of the source (amplitude modulation for the former and frequency modulation for the latter) and heterodyne detection. In FWCM, the sensor locations are relatively restricted in the sense that the spacings between them should be ideally the same and inversely proportional to the frequency scan range. In SOCF, the sensing ranges are limited by the coherent length of the source, which is about a few meters, as the DFB laser source is frequency modulated.

In view of the foregoing, what is needed is a means of implementing optical phase modulation that results in a simpler system configuration, and provides an additional degree of freedom in encoding phase information, among other things.

### SUMMARY OF INVENTION

The present invention provides an optical phase modulation method using optical frequency shift devices. By accurately controlling the frequency shift, the phase delay experienced by the light signal through an optical medium (fibre, free space, vacuum, or other) can be controlled with high resolution. Hence, phase change can be achieved through frequency change, and this technique can be applied to a wide range of applications whenever phase modulation is needed, such as in various phase-shifted keying techniques in optical communications, and in optical metrology. This phase modulation method can also be used as a phase encoding technique in quantum key distribution. When applying the present invention to the interrogation of multiple optical sensors, in contrast to the above-mentioned interrogation techniques, the present invention includes a new cw technique that allows spectral overlap of light from sensors, and does not involve the modulation of the source or heterodyne detection. Instead, it relies on the phase modulation by frequency modulation. In addition, the sensor range is not limited by the coherence length, nor does it require same spacing between sensor elements.

In one aspect of the present invention, a method using an optical interferometer for high resolution optical length (fibre or free space) or location measurements is provided.

In another aspect of the present invention, a method using frequency scan and Fourier analysis for detecting, locating, and analyzing information from multiple optical sensors is provided.

In another aspect of the present invention, a method using balanced detection and lock-in techniques is described, achieving very high sensitivity and allowing extremely low reflections (such as those from defects in fibre, from connector surfaces, and/or from intentionally engineered structures such as fibre Bragg gratings) to be detected and located.

In another aspect of the present invention, a method for high resolution measurement of dispersion is provided.

In yet another aspect of the present invention, an optical phase modulation method based on frequency change is provided, to be used in optical and quantum communications.

In yet further aspects of the present invention, related systems and apparatuses are provided.

### BRIEF DESCRIPTION OF THE DRAWINGS

A detailed description of the preferred embodiments provided herein below by way of example only and with reference to the following diagrams, in which:

FIG. 1 illustrates the set up for a phase modulator using a pair of frequency up-shift and down-shift elements, wherein: 1 & 2 are frequency up-shift and down-shift elements; 3 is optical path (e.g., fiber or free space); and 4 is driver for the frequency shift elements.

FIG. 2A illustrates the set up for a phase modulator with a frequency shift element placed asymmetrically along an optical path, wherein: 1 is a frequency shift element; and 2 & 3 are optical paths (e.g., fiber or free-space) of different lengths. The arrows indicate counter-directional light (or electromagnetic) beam propagation. The two counter-propagating beams incur different phase shifts upon exiting the system.

FIG. 2B illustrates the set up for a phase modulator with a frequency shift element placed asymmetrically in a Sagnac loop, wherein: 1 is a coupler or beam splitter; 2 is a frequency shift element; 3 & 4 are optical paths of different lengths (e.g., fiber or free space). The arrows indicate the direction of light or electromagnetic beam propagation. The two counter-propagating beams inside the loop incur different phase shifts upon exiting the system.

FIG. 3 illustrates the set up of a Sagnac Quantum Key Distribution system using frequency shift based phase modulators, wherein: 1 is a source; 2 is a circulator or beam director; 3 is a coupler or beam splitter; 4 & 10 are phase modulators based on frequency shift elements; 5 & 6 are detectors; 7 & 13 are filters; and 8, 9, 11 and 12 are elements for monitoring.

FIG. 4 illustrates the experimental setup for the fibre length measurement system, wherein: 1 is a source; 2 is an isolator; 3 is a polarization controller; 4 is a coupler or bean splitter; 5 is a frequency shift element; 6 is a detector; and 7 is driver to the frequency shift element.

FIG. 5 illustrates the length measurement results. “o” marks indicate calibration by AGILENT™ 86037C Chromatic Dispersion Test system; “*” marks indicate calibration by tape measure. The solid line is X=Y. For length calculations, n=1.4682 was used (for SMF-28) for both the AGILENT™ system and the present invention.

FIG. 6 illustrates the resolution of the fibre length measurement system. Circular dots indicate twice the standard deviations of the system measured at different fibre lengths. Solid line corresponds to Eq (10) with parameters L₀=100 m, f₀=53 MHZ, fₖ=50 MHz,f_{k+N}=56 MHz, Δf₀/f₀=5×10⁻⁸ and δφ=4×10⁻⁴.

FIG. 7 illustrates the chromatic dispersion measurement for a 20 km SMF-28 fibre. The solid line represents the present invention; the dashed line represents the AGILENT™ 86037C Chromatic Dispersion Test system. Quadratic fits are used in both systems.

FIG. 8 illustrates another experimental setup for the fibre length measurement system, wherein: 1 is a broadband source or laser; 2 is a circulator or beam director; 3 is a coupler or beam splitter; 4 is a polarization controller; 5 is a coupler or beam splitter; 6 is an optical path (e.g., fiber or free-space); 7 is a frequency shift element; 8 is a driver to the frequency shift element; and 9 is a balanced detector.

FIG. 9 illustrates FFT results with equivalent back reflection of −57 dB, and −67 dB. The X axis had been rescaled to distance. Arbitrary unit for Y axis.

FIG. 10 illustrates FFT result from a long fibre constituted by 4 pieces of short fibres with length equal to 203 m, 55 m, 10 m, and 105 m respectively. FC/PC fibre connectors are used to connect fibres together, and the last end was put into matching gel. The X axis had been rescaled to distance. Arbitrary unit for Y axis.

FIG. 11 illustrates a set up for interrogating fiber optical sensor arrays using a frequency shift element in a folded Mach-Zehnder interferometer configuration, wherein: 1 is a broadband source or laser; 2 is a circulator or beam director; 3 is a coupler or beam splitter; 4 is a polarization controller; 5 is a coupler or beam splitter; 6, 7 and 8 are optical sensor elements; 9 is a frequency shift element; 10 is a driver to the frequency shift element; and 11 is a balanced detector.

In the drawings, one embodiment of the invention is illustrated by way of example. It is to be expressly understood that the description and drawings are only for the purpose of illustration and as an aid to understanding, and are not intended as a definition of the limits of the invention.

### DETAILED DESCRIPTION

Electromagnetic signals (including light signals) of different frequencies experience different phase delays as they go through a certain distance in a medium, as the phase change is equal to (2πvn/c)x, where v is the frequency of the electromagnetic signal, c is the speed of light, n is the refractive index of the medium, and x is the distance traveled. Therefore, a phase change in the electromagnetic signal can be introduced by changing the frequency v of the electromagnetic signal, or the distance x it travels in the medium, or the refractive index n of the medium.

The phase change can be measured using an interferometric technique. By knowing and controlling the frequency change, the optical distance (i.e. distance multiplied by the refractive index of the medium) can be deduced by measuring phase, and vice versa. However, since interferometric techniques give the same result whether a phase change is φ, or φ+2 mπ, where m is an integer, a “zero-phase reference” is required in order to determine the optical distance. One prior art method for optical distance/location measurement employing frequency change is a method based on a Michelson interferometer, called the Optical Frequency Domain Reflectometer (OFDR), which requires a reference arm (with a known optical distance and a limited range of variation).

The present invention employs a Sagnac interferometer (or a folded Mach-Zehnder interferometer which works on the same principle as the Sagnac interferometer) with the frequency shift element (such as an acousto-optic modulator) asymmetrically located in the Sagnac loop, eliminating the requirement for a reference arm. This is because the Sagnac interferometer is a loop interferometer, which makes this method self-referencing. By eliminating the reference arm, the range of distance/location measurement is no longer limited by the range of the reference arm variation. For this reason, the method disclosed by the present invention can be used to measure distances from centimeters to tens of kilometers, limited only by the signal strength itself. An additional advantage of the present invention is, unlike the OFDR method, this method does not require the source to have long coherent length. A further advantage of the present invention is that, due to the self-reference and self-interference nature of the technique, strict polarization or stability control is no longer needed for the signal, making the method in the present invention much easier to implement and easier to obtain high-visibility interference resulting in a very high sensitivity.

Furthermore, the present invention is not limited to single distance/location measurements. By employing Fourier analysis, electromagnetic signals (including light signals) can be detected from multiple locations and reflecting/disturbance sites can be located. Therefore, the method in the present invention can be used for applications such as fault location and detection, connector location and detection, and sensor location and detection, along an optical fibre or in free space. This is different from the OTDR (optical time-domain reflectometry) method, which is based on time measurements for locating reflections. The present invention is also different from the previously mentioned OFDR as well as the OLCR (optical low-coherence reflectometry), since both OFDR and OLCR require a reference arm. As an additional advantage, the method described in the present invention does not require dispersion compensation, which is necessary in the OLCR method.

In another application of the present invention, the refractive index of a medium can be deduced given the frequency change and the physical distance the signal travels. Specifically, by measuring the refractive index using the present invention for different frequencies of light (for example, by employing a tunable laser), one can obtain the dispersion of the medium. This method of measuring dispersion is different from the other established methods, such as the OFDR, the time-of-flight technique, and the phase-shifted method. The difference between the present invention and the OFDR has already been discussed previously. The time-of-flight technique is based on a very different principle, in which very short pulses are used and the arrival time of the pulses are measured. The phase-shifted method is also based on a very different principle: the tunable laser source is intensity modulated (usually by an RF signal) and the phase of the intensity modulation at the receiver is compared to a reference electrical signal to determine the optical delay the signal experiences, from which the refractive index is calculated. In contrast, the present invention employs a cw tunable laser source, a frequency shift element, and a Sagnac interferometer requires no reference arm or reference electrical signal, and no time measurement is required.

A further application of the present application is phase modulation based on frequency change. A phase modulator can be realized by a sequence of two frequency shifters, separated by a certain distance: one up-shifts the frequency and the other down-shifts, such that the output frequency of the phase modulator is the same as that of the input. The phase change depends either on the amount of frequency shift or the distance in between the two frequency shifters. For optical applications, prior art on phase modulation employs a change either in the refractive index (such as an electro-optic modulator), or in the distance (such as a piezo-electric transducer-based phase modulator). Intentional phase modulation by changing the frequency of the signal has not been employed in an optical phase modulator. The optical phase modulator can be used in applications such as coherent optical communications (for example, to perform differential phase shifted keying) as well as quantum communications (for example, to implement BB84 quantum key distribution protocol using phase encoding).

There are several main advantages to the phase modulation method of the present invention. First, if a polarization-independent frequency shifter is used, such as acousto-optic modulator, the phase modulator can be polarization-independent, which is a main advantage over the polarization-dependent electro-optic phase modulator. Second, the present invention allows for “frequency-encoding” in a quantum communications system, an encoding method that has never been employed. (Note that polarization encoding, direct phase encoding, and amplitude encoding have been used in quantum communications.) This frequency encoding scheme can be used in conjunction with other encoding techniques to enhance the security of the quantum communication system.

### EXAMPLE 1

In a representative embodiment of the system and method provided by the present invention, a phase modulator based on frequency shift is described.

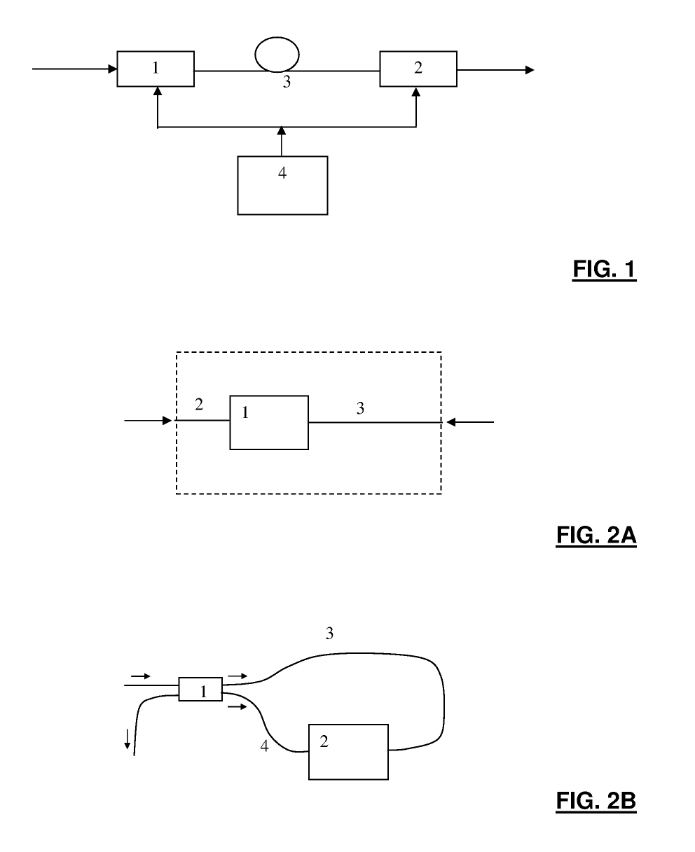

One realization is shown in FIG. 1. The phase modulator consists of two AOMs and a fiber spool between them. The first AOM up-shifts the frequency of the input light signal byf, which is the central frequency of acoustic driver, while the second AOM will down-shift the frequency by the same amount. So after the light pulse goes through the whole device, there is no net frequency shift. The phase modulation is achieved by varying the acoustic frequency.

Suppose the optical length between AOM1 and AOM2 is nL, then the relative phase change induced by the change of acoustic frequency is

$$Δϕ = \frac{2 π nL Δ f}{C}$$

For example, if L=10 m, n=1.46, to achieve a 2π phase change, the change of acoustic frequency is about 10 MHz, which can be easily realized by commercial AOM operating at frequency modulation mode. Potentially, if a high-speed frequency shifter is used, the phase modulator can operate at up to GHz rates.

FIG. 2 shows another realization. A fiber-pigtailed AOM (Brimrose Corp.) was used to achieve the frequency shift. Its working principle is as follows: the acoustic wave generates a propagating diffraction grating inside the crystal. Consequently, the 1st-order diffracted light is Doppler shifted by an amount equal to the frequency of the acoustic signal f. Note the frequency shift (about 10⁸ Hz) is much smaller compare with the optical frequency itself (about 10¹⁴ Hz).

After passing through a 2×2 fiber coupler, the input laser beam was spilt into two parts: the first part, which is labelled as S₁, went clockwise through the fiber loop, while the second part, S₂, went through the same fiber loop counterclockwise. Because both S1 and S2 go through the AOM once, their frequencies will be up-shifted by the same amount. The AOM was placed in the fiber loop asymmetrically, with fiber length on each side as L1 and L2 respectively.

If we define the phase delays induced by the fiber loop to S1 and S2 as φ1 and φ2. Back to the fiber coupler, the relative phase between them is
φ=φ₂−φ₁ (1)

Suppose the wavelength (frequency) of input and output light are λ(ν) and λ′(ν′) respectively. Define Δλ=λ′−λ and Δν=ν′−ν. From λ=C/ν and Δν=f, we can get
Δλ/λ²=−f/C (2)

Where C is the speed of light in vacuum and f is the frequency of driving signal to AOM.

Following the optical paths of S₁ and S₂, it is easy to show
φ₁ 2πnL₁/λ+2πnL₂/λ′ (3a)
φ₂=2πnL₂/λ+2πnL₁/λ′+φ₀ (3b)

Where n is the refractive index of optical fiber, and the constant φ₀ε[0, 2π) is introduced to take into account the phase difference caused by birefringence in the fiber loop.

Using Eqs. (1), (2) and (3), and considering Δλ<<λ, we can get
φ=2πnf(L₁−L₂)/C+φ₀ (4)

From (4), by modulating the driving frequency of AOM, high resolution phase modulation can be achieved. The sensitivity of phase modulation can be easily set to an optimal value by changing the length difference of two fibers.

### EXAMPLE 2

In a representative embodiment of the system and method provided by the present invention, a Sagnac QKD system employing phase modulator based one frequency shift is described.

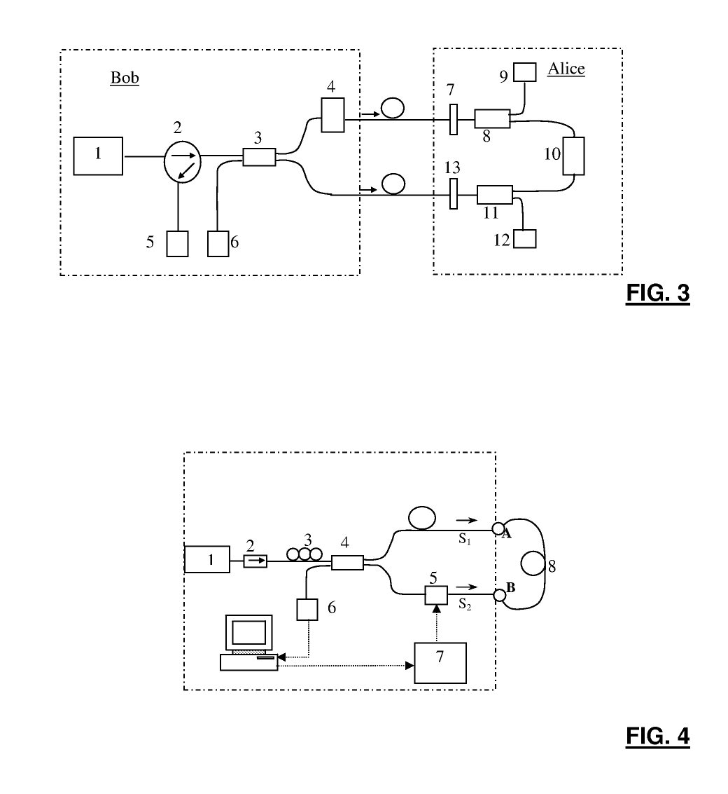

A proposed QKD system based on the AOM-based phase modulator is shown in FIG. 3. On Alice's side, two classical photo detectors (PD₁, PD₂) and two wavelength filters (F₁, F₂) are introduced to fight against Trojan horse attack. These photo detectors can also be used for synchronization purpose. To realize BB84 protocol, Alice randomly encodes her information on the relative phase between clockwise and counterclockwise light pulses with PM₁, while Bob randomly choose his measurement basis with PM₂.

We remark that the newly developed decoy-state QKD protocol, which improves the secure key generation rate of practical QKD system dramatically, can be easily realized in this setup. In decoy-state QKD, Alice randomly adds in decoy pulses, which are used for testing the communication channel, into the signal pulses for key distribution. The decoy pulses are identical to signal pulses except average photon number. Obviously, this can be done easily with the QKD set up presented here: Alice can achieve phase modulation by modulating the frequency of the acoustic signal, in the mean time, she can also modulate the intensity of each pulse by modulating the amplitude of the same AOM driving signal.

### EXAMPLE 3

In a representative embodiment of the present invention, a high-resolution, large dynamic range fibre length measurement system is described, based on a frequency shifted asymmetric Sagnac interferometer incorporating an acousto-optic modulator (AOM). By sweeping the driving frequency of the AOM, which is asymmetrically placed in the Sagnac loop, the optical length of the fibre can be determined by measuring the corresponding variation in the phase delay between the two counter-propagating light beams. Stated another way, the acoustic wave generates a propagating diffraction grating inside the crystal. Consequently, the 1st-order diffracted light is Doppler shifted by an amount equal to the frequency of the acoustic signal f. Combined with a high-resolution data processing algorithm, this rather simple and robust system setup yields a dynamic range from a few centimeters to 60 km, limited only by the availability of long fibres, with a precision on the order of 10⁻⁶ for long fibres. The AOM has an additional advantage of being polarization independent.

FIG. 4 shows the experimental setup for this example of the present invention. A 1550 nm CW laser with a 2 mW output was used as a light source. A fibre-pigtailed AOM (Brimrose Corp.) is used to achieve the frequency shift. After passing through a 2×2 symmetric fibre coupler, the laser beam was split into two parts with equal amplitude: the first part, S1, went clockwise through the fibre loop, while the second part, S2, went through the same fibre loop counterclockwise. The interference signal, produced by S1 and S2 when they came back to the fibre coupler, was measured by an amplified photo detector. Because the frequencies of both S1 and S2 were up-shifted by the same amount, a stable interference signal was observed. A computer with a NATIONAL INSTRUMENTS™ PCI-6115 Data Acquisition card was used to control the function generator (for driving the AOM) and to read the power from the photo detector. Note that a spool of fibre with length LB (about 100 m) was put in the system intentionally. Also, a polarization controller was employed to improve the visibility.

S₁ and S₂ went through the same fibre loop and AOM in different directions. Ideally, any phase drift or polarization fluctuation will be cancelled out. Practically, due to the birefringence in the fibre loop, S₁ and S₂ may experience different phase delays, and their polarization states could also be different after they go through the loop. The interference signal can be described by
V=(1−m cos φ)/(m+1) (5)
where φ=φ₂−φ₁ is the relative phase between S₁ and S₂ after they go through the fibre loop, and the parameter mε[0,1] describes the visibility of the interference fringe.

Suppose the wavelength (frequency) of light before and after going through AOM are λ(ν) and λ′(ν′) respectively. Define Δλ=λ′−λ and Δν=ν′−ν. Given λ=C/ν and Δν=f, then
Δλ/λ²=−f/C (6)
where C is the speed of light in a vacuum.

The phase delays experienced by S₁ and S₂ can be expressed as
φ₁=2πnL₁/λ+2πnL/π+2πnL₂/π′ (7a)
φ₂=2πnL₂/λ+2πnL/π′+2πnL₁/π′+φ (7b)
where n is refractive index of fibre, L is the length of the test fibre, L₁ is the total length of the connecting fibre from the coupler to port A plus the one from port B to AOM and L₂ is the fibre length from AOM to coupler. Constant φ₀ε[0, 2π) is introduced to take into account the phase difference caused by birefringence in the fibre loop.

Using Eqs. (5), (6) and (7), and considering Δλ<<λ, this yields
V={1−m cos[2πnf(L+L₀)/C+φ₀]}/(m+1) (8)
where L₀=L₁−L₂, which is approximately equal to L_{B} (100 m). Therefore the interference pattern V varies periodically with acoustic frequency f. By scanning f while recording V, the fibre length L can be determined from the “period” of V with high resolution. The offset fibre L_{B} is necessary for short fibre measurement: without it, the required frequency scan range to complete one period would be too larger for the AOM.

There are many ways to calculate the length from the interference pattern described by Eq. (8). An obvious way is to calculate its “period” from either FFT or the frequency difference between two minimum points fₖ and f_{k+N} on the interference pattern. Because back-reflection from unwanted surfaces (which contribute to DC background in the interference pattern) or the long term drift of optical components (such as fibre coupler) will not change this “period”, the system is quite robust against environment noise.

From Eq. (8), the acoustic frequency of the k-th minimum point in the interference pattern is
fₖ=(2kπ−φ₀)×C/[2πn(L+L₀)] (9)
so
f_{k+N}−fₖ=NC/[n(L+L₀)] (10)

The fibre length L can be calculated from
L=NC/[n(f_{k+N}−fₖ)]−L₀ (11)

The integer N in Eq. (11) can be determined by counting the number of minimums between fₖ and f_{k+N}. During the derivation of Eq. (11), the unknown constant φ₀ was cancelled out. Also, the parameter m in Eq. (5) does not show up in Eq. (11). This means the system is insensitive to the birefringence in the fibre loop, although the use of a polarization controller can improve the signal to noise ratio. Note, when Eq. (11) is used to calculate the length L, it is assumed that the refractive index n is known.

From Eq. (11), the error of the length measurement ΔL is mainly caused by Δf, which is the error in determining frequencies fₖ and f_{k+N}. Here Δf can be separated into two parts
Δf=Δf₀+Δf_{φ} (12)
Δf₀ is the frequency resolution of the function generator, while Δf_{φ}is the frequency error of the data processing algorithm for fitting the minimum point from the sampling data. It is assumed that the phase error δφ in finding the minimum point is independent of the fibre length. From Eq. (4)
Δf_{φ}={C/[2πn(L+L₀)]}×δφ (13)

By differentiating Eq. (11), and using Eq. (12) and Eq. (13), the relative resolution can be derived to be

$$\begin{matrix}\vert Δ L / L \vert \approx \sqrt{2} \times [ {f}_{0} / ( {f}_{k + N} - {f}_{k} ) ] \times [ ( L + {L}_{0} ) / L ] \times ( Δ f / {f}_{0} ) \\ = \sqrt{2} \frac{{f}_{0}}{{f}_{k + N} - {f}_{k}} \times \frac{L + {L}_{0}}{L} \times \frac{Δ {f}_{0}}{{f}_{0}} + \\ \frac{C}{\sqrt{2} π nL ( {f}_{k + N} - {f}_{k} )} \times δϕ\end{matrix} \qquad ( 14 )$$

In this example, fₖ was chosen to be close to 50 MHz (the lower limit of the working frequency range) while f_{k+N} was chosen to be close to 56 MHz (the upper limit of the working frequency range). For large L, the second term at the right side of Eq. (14) can be neglected, and the resolution of the length measurement is limited by the frequency resolution of the function generator. For short L, the contribution of the phase error δφ cannot be neglected.

For this example of the present invention, a LABVIEW™ program was developed to scan the acoustic frequency, acquire the interference fringe, search for minimum points in the fringe and calculate L. For a 60 km fibre, the visibility of the interference pattern is still about 93% To calibrate the system for short fibre samples, a tape measure was used to determine the actual length, while for long fibres an AGILENT™ 86037C Chromatic Dispersion Test system, which has a length measurement resolution of 0.1%, was used. Spools of CORNING™ SMF28 fibre with different lengths (from 5 m to 60 km) were tested with both the calibration systems and system.

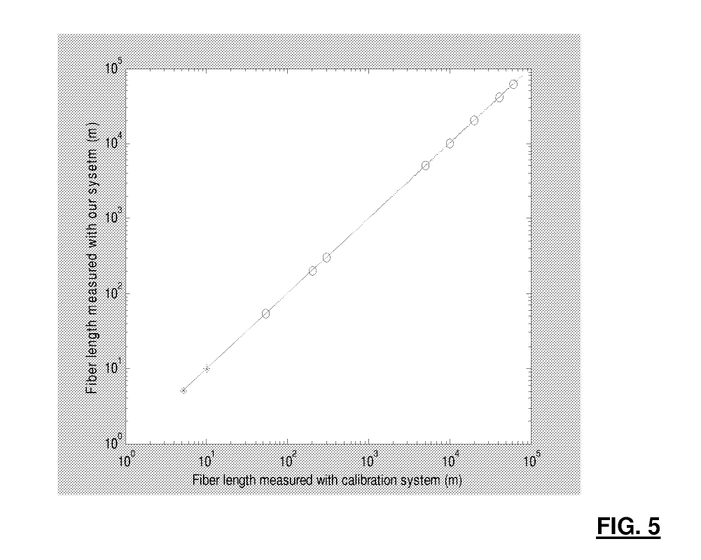

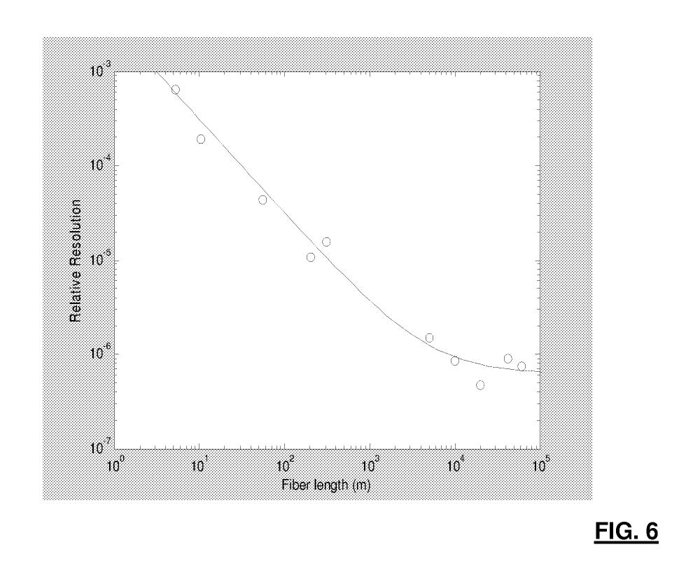

The length measurement results are shown in FIG. 5. The relative differences between the results from the method of the present invention and the AGILENT™ system are less than 0.1% except for a 55 m fibre spool (0.18%), which may be due to the inaccuracy of the AGILENT™ system for short fibre samples. In fact, a 5.18 m fibre (determined by tape measure) was measured by the method of the present invention as 5.20 m, while the AGILENT™ system measured 5.36 m.

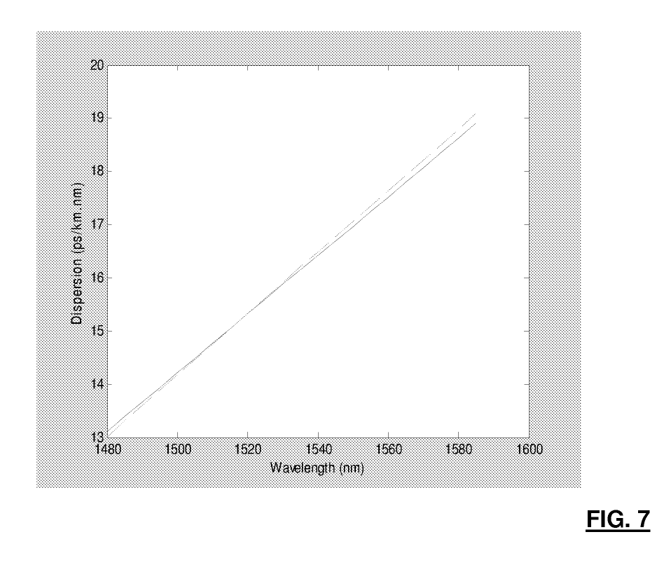

The standard deviations at different fibre lengths were also measured. The resolution is defined as twice of the standard deviation. The experimental results are shown in FIG. 6, which closely match the theoretical model.

The high resolution of the present invention suggests its potential application for chromatic dispersion measurement. In principle, by tuning the wavelength of the light source while recording the optical length, the group delay τ(λ) can be determined. The chromatic dispersion can be calculated from
D(λ)=(∂τ/∂λ)/L (15)

A preliminary dispersion measurement was conducted by employing a tunable laser with a tuning range of 1480 nm-1585 nm. FIG. 7 shows a comparison between the dispersion result obtained from the present invention and that from the AGILENT™ system. The slight discrepancy may be attributed to the wavelength dependence of the components in the system, which was not calibrated.

### EXAMPLE 4

In a representative embodiment of the system and method provided by the present invention, a frequency shifted folded Mach-Zehnder interferometer (“MZI”) for locating multiple weak reflections along a fibre link is described. Using a low cost broadband light source and a simple balanced photo detector combined with lock-in detection and FFT techniques, the feasibility of locating multiple weak Fresnel reflectors along one fibre has been demonstrated. This is a potentially useful scheme for fibre optical sensor multiplexing.

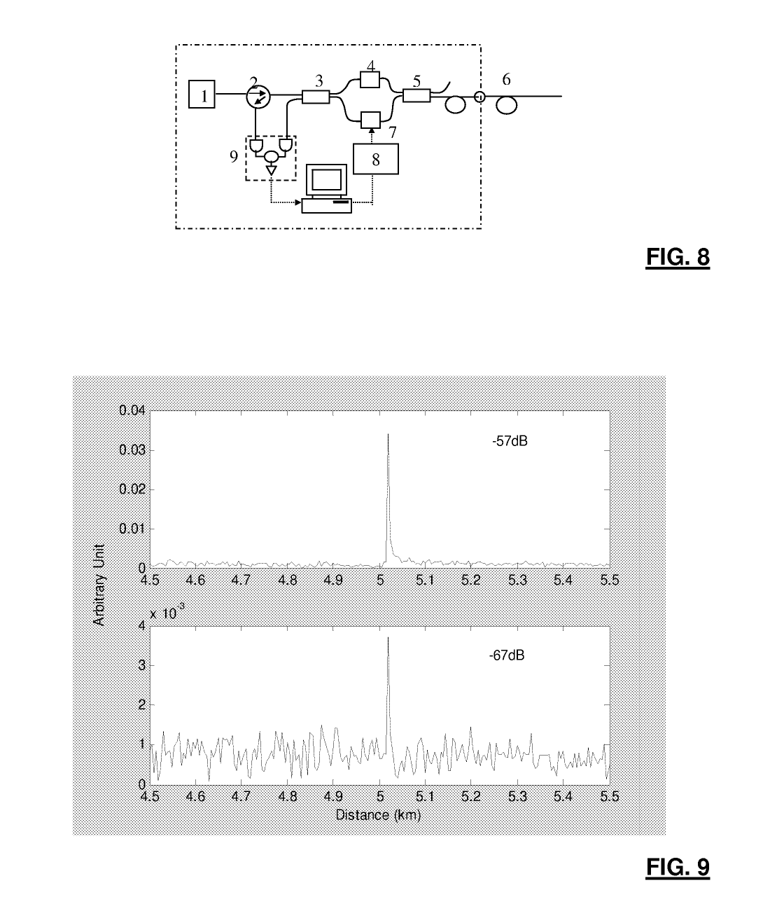

FIG. 8 shows the diagram of the experimental setup for fibre length measurement for this example of the present invention. The light source is a 10 mw CW broadband source with central wavelength 1550 nm (AFC™ BBS 1550A-TS). Two symmetric fibre couplers, C₁ and C₂, constitute a fibre MZI, with a polarization controller (PC) on path 1 and a fibre-pigtailed AOM (Brimrose Corp.) on path 2. After it goes through a fibre circulator, the light beam is split by C₁ into two parts which go through path 1 and path 2, respectively. The length unbalance between path 1 and path 2 is much larger than the coherence length of the light source (which is about 60 μm), so the two light beams will not interfere with each other at C₂. Instead, both of them will be coupled into test fibre (with 50% coupling efficiency) and propagates through it. At the cleaved end of the test fibre, about 3.5% optical power will be reflected back and split by the fibre coupler C₂ again. In total, there are four signals travelling back to the fibre coupler C₁ which are named as Eᵢⱼ (i,j=1,2): the first subscript indicates via which path of MZI the signal goes out, the second subscript indicates via which path of MZI the signal travels. A balanced detector (NEW FOCUS™, Model 2117) is used to record the interference signal. The losses of two channels are carefully balanced with variable optical attenuators. A personal computer with a NATIONAL INSTRUMENTS™ PCI-6115 Data Acquisition card is used to control a function generator (for driving the AOM) and to read the output from the balanced detector. Note that a spool of fibre with length L₀ (about 100 m) is put in the system for short fibre measurement, as explained below. Also, a polarization controller is employed to improve the visibility.

Each time the light beam goes through the AOM, its frequency will be up-shifted by an amount equal to the frequency of the acoustic signal fₐ. Following the paths of Eᵢⱼ, it's easy to show that E₁₂ and E₂₁ experience exactly the same frequency shift (fₐ), while E₁₁ (E₂₂) has a frequency shift of 0 (2fₐ). Furthermore, E₁₂ and E₂₁ go through exactly same fibre paths, while the paths for E₁₁ and E₂₂ are different. So E₁₂ and E₂₁ will interfere with each other at C₁ while E₁₁ and E₂₂ only contribute to DC background, which can be taken out by balanced detection.

The normalized interference signals from chan1 and chan2 can be described as
I₁=(1+cos φ)/2+B.G. (16a)
I₂=(1−cos φ)/2+B.G. (16b)

Here φ is the relative phase between E₁₂ and E₂₁, B. G. represents DC background contributed by E₁₁, E₂₂ and other additional reflections. So the normalized differential signal from balanced detector is
V=cos φ (17)

Define the phase delays of E₁₂ and E₂₁ as 100 ₂ and φ₃, respectively, so
φ=φ₃−φ₂ (18)

Suppose the wavelength (frequency) of light before and after going through AOM one time are λ(ν) and λ′(ν′) respectively. Define Δλ=λ′−λ and Δν=ν′−ν. Given λ=C/ν and Δν=fₐ, then
Δλ/λ²=−fₐ/C (19)
where C is the speed of light in a vacuum.

Following the paths of E₁₂ and E₂₁, it is easy to show that
φ₂=4πn(L+L₀)/λ (20a)
φ₃=4πn(L+L₀)/λ′ (20b)

Here, n is refractive index, L is the length of the test fibre and L₀ represents the 100 m offset fibre in the system. The phase delay induced by short fibres in MZI is neglected. Their contributions are constant, and can be easily removed by adjusting the zero point.

Using (18), (19), (20), Eq. (17) becomes
V=cos[4πn(L+L₀)fₐ/C] (21)

By scanning the acoustic frequency fₐ, while recording the interference pattern, the fibre length L can be determined from the “period” of the interference pattern. Because of the limited frequency scanning range of AOM, the fibre loop L₀ is critical for short fibre measurement. Without it, the required frequency scan range would be too larger for the AOM.

Note (21) is based on the assumption that there is only one dominant reflection site along the fibre. In practical optical communication network, normally, the back reflections from defects or fibre connectors in fibre links are much weaker than that from a cleaved fibre end. Also, there maybe more than one reflection sites along one fibre. Because the system works in CW mode, at the receiver's end, interference signals from different reflection sites are overlapped in time. To separate these signals, FFT technique can be employed.

Compare (21) V(fₐ)=cos[4πnLfₐ/C] (here, L₀ is neglected for simplicity) with a conventional time domain Sine signal S(t)=cos[2πft], there is the correspondence of t<=>fₐ; f<=>2nL/C. From the theory of Discrete Fourier Transform (DFT), for a serial of samples of signal S(t) in time domain with sampling window T, the frequency resolution of its DFT is 1/T. Similarly, for the interference signal V(fₐ), if the frequency scan range of the acoustic signal fₐ is Δ, then the spatial resolution will be
δL=C/(2nΔ) (22)

Normally, the working frequency range of AOM is limited; this in turn determines the ultimate resolution of length measurement by using FFT.

For this example of the present invention, a LABVIEW™ program was developed to scan the acoustic frequency fₐ, acquire the interference fringe V(fₐ), and then calculate fibre length L from the “period” of V(fₐ) by using (6). To calibrate the system for short fibres, a tape measure was used to determine its geometrical length, while for long fibres an AGILENT™ 86037C Chromatic Dispersion Test System (CDTS) was used. The length resolution of CDTS is 0.05 m or 0.1%, whichever is larger. Spools of CORNING™ SMF28 fibre with different lengths (from 5 m to 60 km) were tested with both the calibration systems and the example system. The length measurement results are shown in Table 1.

TABLE 1
Results of fibre length measurement (m)
(n = 1.4682 was used for both CDTS and the example system).

| Example | Tape measure | CDTS |
|---|---|---|
| 5.189 ± 0.001 | 5.18 ± .01 | 5.36 ± 0.05 |
| 10.164 ± 0.001 | 10.18 ± 0.01 | 10.33 ± 0.05 |
| 54.458 ± 0.001 | | 54.60 ± 0.05 |
| 203.379 ± 0.00 | | 203.4 ± 0.2 |
| 5037.599 ± 0.0 | | 5034 ± 5 |
| 10069.635 ± 0. | | 10063 ± 10 |
| 19888.12 ± 0.0 | | 19875 ± 20 |
| 41138.76 ± 0.0 | | 41112 ± 40 |
| 61074 ± 10 | | 60988 ± 60 |

In Table 1, the resolution of measurements of the present invention is defined as twice of the standard deviation, while for CDTS the values are from its manual. The resolution of measurements of the present invention is about 1 mm for fibre short than 10 km. The relatively higher fluctuation for 60 km fibre could be caused by the contribution from other reflection sites, which cannot be neglected being the high fibre loss experienced by the end face reflection in this case. Note the resolution of measurements of the present invention is much higher than CDTS in the whole range, and the measurement results of tape measure demonstrated the accuracy of the present invention is also better than CDTS at least for short fibre.

In a further aspect of this example, lock-in detection and FFT techniques were incorporated to improve the sensitivity of the method of the present invention and separate signals from multiple reflection sites. In this arrangement, the frequency of acoustic signal was scanned at a relative low speed, while also modulated at a small frequency range. Frequency scan and modulation was achieved using two AOMs: AOM1, which was driven by a function generator, was used to achieve frequency modulation; AOM2, which was driven by a frequency variable AOM driver, was used to achieve frequency scan. (In principle, frequency scan and modulation can be achieved with only one AOM.) The function generator also generated the reference signal for the lock-in amplifier (STANFORD RESEARCH SYSTEMS™, SR850), whose input was connected with the output of the balanced detector. A digital oscilloscope was used to sample and store the output from Lock-in amplifier. Data processing was done using MATLAB™ offline.

To determine the sensitivity of the improved system, a variable optical attenuator (VOA) was added between the measurement system and a 5 km test fibre. Back reflection from the cleaved fibre end face (about −14.5 dB) was measured at different VOA settings. Given 1.25 dB loss from the 5 km, as the attenuation of VOA was set to A, the equivalent back reflection was estimated as [2×(A−1.25)−14.5]dB. Here, the factor 2 takes into account of double passes. The FFT results of the interference signal at different VOA settings are shown in FIG. 9. At −67 dB back reflection, the signal is still clearly above noise. Note as the back reflection decreases from −57 dB to −67 dB, the amplitude of the corresponding peak also drops about one order. This indicates that this technique not only can be used to locate the position of the reflection site, but also can be used to determine the reflectivity.

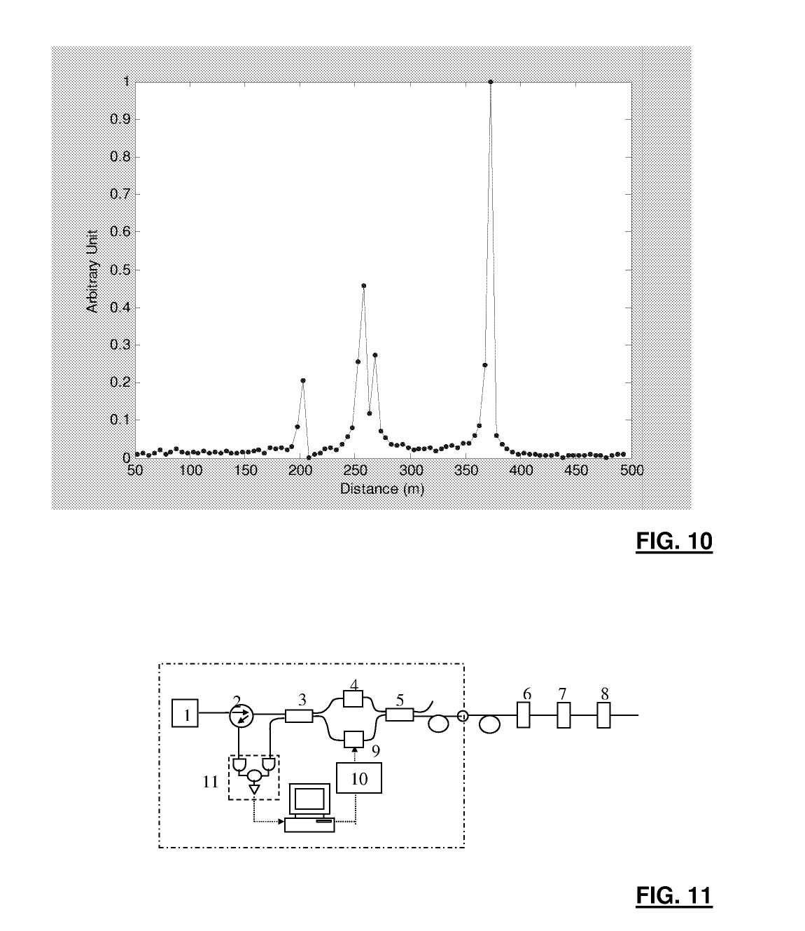

With FFT, it is possible to separate back reflections from different reflection sites along one fibre. The working frequency range of the AOM2 for frequency scan is 20 MHz. From (22), the length resolution with FFT is about 5 m. In a second test, four pieces of fibre with length 203 m, 55 m, 10 m and 105 m are connected together with FC/PC connectors. One end of this multiple-pieces fibre was connected with the measurement system, while the other end was put in matching gel. The FFT result of acquired interference signal is shown in FIG. 10. Four peaks are clearly visible. The spatial resolution can be improved further by employing another frequency shifter to extend the frequency scan range.

### EXAMPLE 5

In a representative embodiment of the system and method provided by the present invention, a set up for interrogating fiber optical sensor arrays is described.

FIG. 11 shows the experimental setup for interrogation of multiplexed fiber grating sensors. Despite its Mach-Zehnder appearance, the setup is more akin to an asymmetric frequency shifted Sagnac interferometer. A tunable cw laser source (TLS) is used as the light source. A fiber-pigtailed acoustic optical modulator (AOM) with a first-order diffracted output serves as the frequency shifter. After light goes through a fiber circulator, it is split equally by a 3 dB coupler C1 into two parts (E₁ and E₂) which go through path 1 and 2, respectively, as shown in FIG. 11. The TLS was operated at the low-coherence mode with an 80 MHz linewidth, corresponding to ˜0.5 m coherent length. When the length unbalance between the path 1 and 2 is longer than this coherent length, E₁ and E₂ do not interfere at C2. Instead, each goes through C2, is then reflected by a grating and returns back into the loop through C2. They are again split equally at C2, resulting in four components arriving at C1, as expressed in Eq. (23).

$$E = {ⅇ}^{j ( 2 π ft - \frac{4 π {n}_{eff} f \cdot {L}_{i}}{c} - {ϕ}_{1} )} + {ⅇ}^{j [ 2 π ( f + {f}_{a} ) t - \frac{4 π {n}_{eff} f \cdot {L}_{i}}{c} - {ϕ}_{2} ]} + {ⅇ}^{j [ 2 π ( f + {f}_{a} ) t - \frac{4 π {n}_{eff} ( f + {f}_{a} ) {L}_{i}}{c} - {ϕ}_{3} ]} + {ⅇ}^{j [ 2 π ( f + 2 {f}_{a} ) t - \frac{4 π {n}_{eff} ( f + {f}_{a} ) {L}_{i}}{c} - {ϕ}_{4} ]} \qquad ( 23 )$$

where c is the velocity of light in vacuum, n_{eff} is the effective refractive index of the fiber, f is the optical frequency, and fₐ, is the frequency shift produced by the AOM. Lᵢ is the length of fiber between C2 and the grating, while φₘ (m=1, 2, 3, 4) correspond to the additional phase delays introduced by the various fiber lengths between C1 and C2. For simplicity, the amplitudes of all reflected lights are normalized to unity. The first two terms are contributed by the reflection of E₁ while the second two terms by E₂. Note the last term has 2fₐ, frequency shift as the signal passes through the AOM twice. The intensity outputs at the two ports of C1 become:

$${I}_{1 , 2} = \frac{1}{2} \frac{1}{T} {\int }_{- T / 2}^{T / 2} {\vert E \vert}^{2} ⅆ t = 2 \pm sin [ 4 π {n}_{eff} {f}_{a} {L}_{i} / c + {ϕ}_{2} - {ϕ}_{3} ] \qquad ( 24 )$$

where “+” corresponds to one of the output ports, “+” corresponds to the other output, and T is the response time of the balanced detector. The dc background can be effectively removed by the balanced detector for an enhanced SNR. For the case of N gratings with reflectivities Rᵢ(λ) at locations Lᵢ (i=1, 2, 3, . . . N), the output of the balanced detector is then given by:

$$I = {I}_{1} - {I}_{2} = {\sum }_{i = 1}^{N} {R}_{i} ( λ ) \cdot sin ( \frac{4 π {n}_{eff} {L}_{i}}{c} sw \cdot t ) \qquad ( 25 )$$

where fₐ=F₀+sw. t, SW is frequency sweep rate, F₀ is the starting frequency of AOM. Note that the constant coefficient and the phases produced by F₀ and φ₂-φ₃ are neglected. Clearly, when a Fourier Transform (FT) is applied to the intensity signal obtained with frequency sweep (i.e. Eq. (25)), the grating location information is obtained from the frequency of the Fourier components, while the grating reflectivities are proportional to the amplitudes of the Fourier components. By tuning the laser wavelength, the reflection spectrum for each grating Rᵢ(λ) is therefore obtained regardless whether the grating spectra overlapped or not. The grating locations (Lᵢ) is obtained as:

$${L}_{i} = \frac{c}{2 {n}_{eff} sw} {F}_{i} \qquad ( 26 )$$

where Fᵢ (i=1, 2, 3, . . . N) are the frequencies of Fourier components.

What is claimed is:

1. A method for encoding phase information on an electromagnetic signal using frequency change, the method comprising:
(a) placing two or more frequency shifting elements along a length of a carrier means operable to carry the electromagnetic signal, wherein the two or more frequency shifting elements are spaced apart along the length of the carrier means; and
(b) applying frequency change to the electromagnetic signal by operation of the frequency shifting elements so as to encode phase information on the electromagnetic signal.

2. The method of claim 1 wherein the electromagnetic signal is a light signal.

3. The method of claim 1, whereby the frequency shifting elements consist of:
(a) an acousto-optic modulator, or a surface acoustic wave (SAW) based frequency shifter, or an electro-optic frequency shifter; and
(b) an intensity modulated coherent source with frequency shifted sideband filtered out after modulation.

4. The method of claim 3 wherein the coherent source is a laser source.

5. The method of claim 1 further comprising using an interferometer.

6. The method of claim 5 wherein the interferometer is a Sagnac interferometer or a folded Mach-Zehnder interferometer.

7. The method of claim 1 wherein the encoding achieves encoding of a quantum state, as in quantum key distribution.

8. A method for introducing a phase change in an electromagnetic signal using frequency change, the method comprising:
(a) placing two or more frequency shifting elements along a length of a carrier means operable to carry the electromagnetic signal, the electromagnetic signal having a phase, wherein the two or more frequency shifting elements are spaced apart along the length of the carrier means; and
(b) applying frequency change to the electromagnetic signal by operation of the frequency shifting elements so as to modify the phase of the electromagnetic signal.

9. The method of claim 8, wherein the frequency shifting elements consist of:
(a) an acousto-optic modulator, or a surface acoustic wave (SAW) based frequency shifter, or an electro-optic frequency shifter; and
(b) an intensity modulated coherent source in which the frequency shifted sideband is filtered out after modulation.

10. A method for measuring optical path length of an optical signal or locating faults/disturbances in the optical path, the method comprising:
(a) providing an optical source;
(b) providing a self-referencing loop interferometer, such that the optical source is optically accessible from the loop interferometer, the loop interferometer having a plurality of ports, the loop interferometer being operable to generate an interference signal based on the optical source;
(c) placing at least one frequency shift element asymmetrically inside the loop interferometer;
(d) providing at least one detector operable to detect the interference signal at either of the plurality of ports of the loop interferometer; and
(e) deriving optical path length or fault/disturbance data from the detected interference signal.

11. The method of claim 10 wherein the optical source is a laser or a low-coherence broadband source.

12. The method of claim 10, wherein the loop interferometer is a Sagnac interferometer or a fold Mach-Zehnder interferometer.

13. The method of claim 10, wherein the frequency shift element consists of one or more acousto-optic modulators or electro-optic frequency shifters, or frequency shifting is provided by intensity modulation of a coherent source and by filtering out the frequency shifted sideband after modulation.

14. The method of claim 13, whereby a frequency scan is employed.

15. The method of claim 10, further comprising providing a balanced detector that is operable to detect the difference in signal between the plurality of ports of the loop interferometer.

16. The method of claim 10, further comprising using a lock-in detection system for the measurement of the optical signal, whereby the frequency shift element is also amplitude or frequency modulated to facilitate lock-in detection.

17. The method of claim 10, further comprising applying Fourier analysis or a Matrix pencil method for locating multiple reflection sites or multiple length measurements in a series, wherein the multiple reflection sites include faults, connectors, or other disturbances that cause back reflection or scattering.

18. The method of claim 17, whereby multiple reflection sites are located by:
(a) sensors placed along a fibre carrying the optical signal; or (b) sensors placed in free-space where they are accessible optically.

19. A method for measuring the dispersion of an optical medium, the method comprising:
(a) providing a wavelength-tunable laser;
(b) providing a Sagnac interferometer, such that the optical medium is optically accessible from the interferometer, the interferometer having a plurality of ports, the interferometer being operable to generate an interference signal based on the laser;
(c) placing at least one frequency shift element asymmetrically inside the interferometer;
(d) providing at least one detector operable to detect the interference signal at either of the plurality of ports of the interferometer;
(e) measuring the refractive index for different frequencies of light associated with the optical medium by operation of the wavelength-tunable laser, the interferometer and the at least one detector; and
(f) deducing the dispersion of the optical medium from the refractive indices.

20. A phase modulator comprising two or more frequency shifting elements placed along a length of a carrier means operable to carry an electromagnetic signal, wherein the two or more frequency shifting elements are spaced apart along the length of the carrier means, wherein the electromagnetic signal has a phase associated with it, and wherein the frequency shifting elements are operable to apply frequency change to the electromagnetic signal so as to modulate the phase of the electromagnetic signal.

21. A system that is operable to change phase in a controlled manner, the system comprising a phase modulator as described in claim 20.

22. A data processor for processing phase encoded data, the data processor comprising a phase modulator as described in claim 20.

23. A system for encoding phase information on an electromagnetic signal using frequency change, the system comprising:
(a) two or more frequency shifting elements;
(b) a length of a carrier means operable to carry the electromagnetic signal, wherein the two or more frequency shifting elements are disposed on the length of the carrier means and spaced apart along the length of the carrier means; and
(c) one or more data processors connected to the frequency shifting elements, wherein the data processors are operable to direct the frequency shifting elements to apply frequency change to the electromagnetic signal so as to phase encode data information on the electromagnetic signal.

24. A system for locating optical defects or Bragg gratings on an optical fiber, the system comprising:
(a) an optical source;
(b) a self-referencing loop interferometer, wherein the optical source is optically accessible from the loop interferometer, the loop interferometer having a plurality of ports, the loop interferometer being operable to generate an interference signal based on the optical source;
(c) at least one frequency shift element, wherein the at least one frequency shift element is disposed asymmetrically inside the loop interferometer; and
(d) at least one detector operable to detect the interference signal at either of the plurality of ports of the loop interferometer, wherein the detector provides location data for the optical defects or Bragg gratings.

25. The system of claim 24, wherein the optical source is a laser or low-coherence broadband source.

26. The system of claim 24, wherein the loop interferometer is a Sagnac interferometer or a fold Mach-Zehnder interferometer.

27. The system of claim 24, wherein the frequency shift element consists of at least one acousto-optic modulator or electro-optic frequency shifter, or such frequency shifting is provided by intensity modulation of a coherent source and by filtering out the frequency shifted sideband after modulation.

28. An apparatus for phase modulation based on frequency change, the apparatus comprising at least two frequency shifting elements disposed along a length of a carrier means operable to carry an electromagnetic signal, the electromagnetic signal having a phase, wherein the two or more frequency shifting elements are spaced apart along a length of the carrier means, and wherein the two or more frequency shifting elements are operable to apply frequency change to the electromagnetic signal so as to modulate the phase of the electromagnetic signal.

29. An apparatus for quantum encryption based on frequency change, the apparatus comprising at least two frequency shifting elements disposed along a length of a carrier means operable to carry an electromagnetic signal, the electromagnetic signal having a phase, wherein the two or more frequency shifting elements are spaced apart along a length of the carrier means, and wherein the two or more frequency shifting elements are operable to control phase changes to the electromagnetic signal so as to modulate the phase of the electromagnetic signal between binary states.

30. A method for encoding phase information on an electromagnetic signal using frequency change, the method comprising:
(a) placing at least one frequency shifting element along a length of a carrier means operable to carry the electromagnetic signal, wherein the frequency shifting element is located asymmetrically along the length of the carrier means, and the frequency shifting element and the length of the carrier means is used in a bidirectional fashion or in a loop consisting of two counter-propagating carriers; and
(b) applying frequency change to the electromagnetic signal by operation of the frequency shifting element so as to encode phase information on the electromagnetic signal.

31. A method for introducing a phase change in an electromagnetic signal using frequency change, the method comprising:
(a) placing at least one frequency shifting element along a length of a carrier means operable to carry the electromagnetic signal, wherein the frequency shifting element is located asymmetrically along the length of the carrier means, and the frequency shifting element and the length of the carrier means is used in a bidirectional fashion or in a loop consisting of two counter-propagating carriers; and
(b) applying frequency change to the electromagnetic signal by operation of the frequency shifting element so as to modify the phase of the electromagnetic signal.

32. A phase modulator comprising at least one frequency shifting element placed along a length of a carrier means operable to carry the electromagnetic signal, wherein the frequency shifting element is located asymmetrically along the length of the carrier means, and the frequency shifting element and the length of the carrier means is used in a bidirectional fashion or in a loop consisting of two counter-propagating carriers, and wherein the frequency shifting element is operable to apply frequency change to the electromagnetic signal so as to modulate the phase of the electromagnetic signal.

33. A system for encoding phase information on an electromagnetic signal using frequency change, the system comprising:
(a) one or more frequency shifting elements;
(b) a length of a carrier means operable to carry the electromagnetic signal, wherein the one or more frequency shifting elements are disposed on the length of the carrier means; and
(c) one or more data processors connected to the one or more frequency shifting elements, wherein the data processors are operable to direct the one or more frequency shifting elements to apply frequency change to the electromagnetic signal so as to phase encode data information on the electromagnetic signal.
